(19) United States
(12) Patent Application Publication
(10) Pub. No.: US 2026/0284580 A1
(43) Pub. Date: Sep. 24, 2026

(54) ACID GAS REMOVAL APPARATUS AND ACID GAS REMOVAL METHOD

(71) Applicants: KABUSHIKI KAISHA TOSHIBA, Kawasaki-shi (JP); TOSHIBA ENERGY SYSTEMS & SOLUTIONS CORPORATION, Kawasaki-shi (JP)

(72) Inventors: Hitomi SAITO, Taito (JP); Reiko YOSHIMURA, Kawasaki (JP); Akiko SUZUKI, Ota (JP); Asato KONDO, Yokohama (JP); Shinji MURAI, Sagamihara (JP); Takehiko MURAMATSU, Yokohama (JP)

(73) Assignees: KABUSHIKI KAISHA TOSHIBA, Kawasaki-shi (JP); TOSHIBA ENERGY SYSTEMS & SOLUTIONS CORPORATION, Kawasaki-shi (JP)

(21) Appl. No.: 19/550,504

(22) Filed: Feb. 26, 2026

(30) Foreign Application Priority Data
Mar. 19, 2025 (JP) 2025-045942

(51) Int. Cl. B01D 53/14; B01D 53/18; B01D 53/34; B01D 53/62; B01D 53/78; B01D 53/96; B01D 61/36; B01D 69/02

(52) U.S. Cl. CPC B01D 53/1425; B01D 53/1475; B01D 53/1493; B01D 53/18; B01D 53/343; B01D 53/62; B01D 53/78; B01D 53/96; B01D 61/362; B01D 61/3621; B01D 69/02; B01D 2252/20447; B01D 2252/20484; B01D 2257/504; B01D 2258/0283; B01D 2325/38

(57) ABSTRACT

The present embodiment provides an apparatus and a method capable of removing acid gas while removing degradation products generated during operation. There is provided an acid gas removal apparatus according to the present embodiment including:
an absorber that brings a gas to be treated into contact with an acid gas absorption liquid to absorb the acid gas in the gas to be treated into the acid gas absorption liquid; and
a regenerator that desorbs the acid gas from the acid gas absorption liquid after acid gas absorption to regenerate the acid gas absorption liquid, in which
a separator that separates a nonionic organic compound contained in the acid gas absorption liquid is further provided, and
the separator includes a hydrophobic membrane and selectively separates the degradation product.

### CROSS REFERENCE TO RELATED APPLICATIONS

This application is based upon and claims the benefit of priority from the prior Japanese Patent Application No. 2025-045942, filed on Mar. 19, 2025, the entire contents of which are incorporated herein by reference.

### FIELD

Embodiments of the present invention relate to an acid gas removal apparatus and an acid gas removal method. Embodiments of the present invention also relate to a separator that separates a nonionic organic compound contained in the acid gas absorption liquid from the acid gas absorption liquid.

### BACKGROUND

In recent years, the greenhouse effect caused by the increase in carbon dioxide (CO₂) concentration has been pointed out as one of the causes of global warming, and international measures to protect the environment on a global scale have become an urgent issue. The generation of CO₂ is largely due to industrial activities, and momentum is increasing for the suppression of emission of CO₂ into the environment.

In order to suppress the increase in the concentration of acid gases including CO₂, the development of energy-saving products, the development of technologies for the utilization of acid gases as resources or for their sequestration and storage, and the shift to alternative energies such as natural energy and nuclear energy that do not emit acid gases are being considered, and among these, the technology for separating and recovering emitted acid gases is also being studied.

Acid gas separation technologies that have been studied to date include absorption methods, adsorption methods, membrane separation methods, and cryogenic methods. Among these, the absorption method is suitable and economical for processing large volumes of gas efficiently, and since scaling up of the removal apparatus is easy, application to factories and power plants is being considered.

As a method mainly targeted at thermal power plants that use fossil fuels, a method is known in which exhaust gas generated during the combustion of fossil fuels (such as coal, oil, and natural gas) is brought into contact with an acid gas absorption liquid containing amine compounds such as alkanolamines, represented by monoethanolamine (MEA), to remove and recover CO₂ from the exhaust gas, and furthermore, a method for storing the recovered CO₂ is also known.

For the recovery of CO₂, it is required that the CO₂ absorption step into the acid gas absorption liquid containing amine compounds and the CO₂ desorption step from the acid gas absorption liquid that has absorbed CO₂ (in most cases by heating at 100° C. or higher) are carried out with high efficiency, and that the recovery energy consumed for CO₂ recovery in the process is also low. What becomes a problem in such a CO₂ recovery system is the degradation of the amine compounds due to heating during CO₂ release (recovery). Since exhaust gas (acid gas) contains oxygen, when heated at 100° C. or higher, the amine compounds in the acid gas absorption liquid are oxidized by the oxygen, and it is known that the higher the heating temperature, the more the degradation progresses. The degradation products often include multiple types with differing heat resistance and ionic properties, and with each repetition of the absorption and release cycle, the degradation of the amine compounds progresses, and the degradation products accumulate in the acid gas absorption liquid. For this reason, the repeated use of the acid gas absorption liquid can lead to a decrease in the concentration of amine compounds, which may become a factor in the gradual decrease of CO₂ absorption performance.

### BRIEF DESCRIPTION OF THE DRAWINGS

FIG. 1 is a schematic view of an acid gas removal apparatus according to an embodiment;

FIG. 2 is a schematic view illustrating a separator used in an embodiment;

FIG. 3 is a schematic view of an acid gas removal apparatus according to another embodiment;

FIG. 4 is a schematic view illustrating another separator used in an embodiment; and

FIG. 5 is a schematic view of an acid gas removal apparatus according to another embodiment.

### DETAILED DESCRIPTION

An object of the present embodiment is to provide an acid gas removal apparatus and an acid gas removal method capable of separating and removing a degradation product with high efficiency.

According to the present embodiment, there is provided an acid gas removal apparatus including:
an absorber that brings a gas to be treated containing acid gas into contact with an acid gas absorption liquid containing an amine compound to absorb the acid gas in the gas to be treated into the acid gas absorption liquid; and
a regenerator that desorbs the acid gas from the acid gas absorption liquid after acid gas absorption to regenerate the acid gas absorption liquid, in which
the acid gas absorption liquid regenerated by the regenerator is reused in the absorber,
the acid gas removal apparatus further comprises a separator that separates a nonionic organic compound contained in the acid gas absorption liquid after the acid gas absorption from the acid gas absorption liquid,
the separator is provided with a hydrophobic membrane, brings the acid gas absorption liquid derived from the absorber into contact with the hydrophobic membrane, and separates the nonionic organic compound by allowing the nonionic organic compound to permeate the hydrophobic membrane, and
the acid gas absorption liquid after the nonionic organic compound is separated by the separator is capable of being supplied to the regenerator.

According to the present embodiment, there is provided an acid gas removal method including:
an absorption step of bringing a gas to be treated containing acid gas into contact with an acid gas absorption liquid containing an amine compound to absorb the acid gas in the gas to be treated into the acid gas absorption liquid; and
a regeneration step of desorbing the acid gas from the acid gas absorption liquid after acid gas absorption to regenerate the acid gas absorption liquid, in which
the acid gas absorption liquid regenerated in the regeneration step is reused in the absorption step,
the acid gas removal method further comprises a separation step of separating a nonionic organic compound contained in the acid gas absorption liquid treated in the acid gas absorption step from the acid gas absorption liquid, and
the separation step brings the acid gas absorption liquid treated in the absorption step into contact with a hydrophobic membrane, and separates the nonionic organic compound by allowing the nonionic organic compound to permeate the hydrophobic membrane, and
the acid gas absorption liquid after the nonionic organic compound is separated by the separation step is subjected to the regeneration step.

In addition, according to the present embodiment, there is provided a separator that separates a nonionic organic compound contained in an acid gas absorption liquid after acid gas absorption from the acid gas absorption liquid, in which
the separator is provided with a hydrophobic membrane, brings the acid gas absorption liquid into contact with the hydrophobic membrane, and separates the nonionic organic compound by allowing the nonionic organic compound to permeate the hydrophobic membrane, and
the separated nonionic organic compound is a gas.

Embodiments will now be explained with reference to the accompanying drawings.

In the following embodiment, a case where the acid gas is carbon dioxide will be described as an example, but the acid gas removal apparatus and the acid gas removal method according to the embodiment of the present invention can obtain the same effect with respect to other acid gases such as hydrogen sulfide.

The acid gas removal apparatus in the present embodiment is obtained by combining a conventionally known acid gas removal apparatus with a separator for separating and removing a degradation product generated in an acid gas absorption liquid by operation. Hereinafter, an acid gas removal apparatus according to an embodiment will be described.

### <Acid Gas Removal Apparatus>

An acid gas removal apparatus according to an embodiment includes:
an absorber that brings a gas to be treated containing an acid gas into contact with an acid gas absorption liquid containing an amine compound to absorb the acid gas in the gas to be treated into the acid gas absorption liquid; and
a regenerator that desorbs an acid gas from an acid gas absorption liquid after acid gas absorption to regenerate the acid gas absorption liquid. Then, the acid gas absorption liquid absorbs the acid gas in the absorber, the acid gas absorption liquid having absorbed the acid gas is introduced into the regenerator and regenerated, and the regenerated acid gas absorption liquid is introduced into the absorber and reused.

The acid gas removal apparatus according to the embodiment further includes a separator that separates the nonionic organic compound contained in the acid gas absorption liquid after acid gas absorption from the acid gas absorption liquid. This nonionic organic compound is a degradation product generated in the acid gas absorption liquid.

The separator includes a hydrophobic membrane, and the acid gas absorption liquid derived from the absorber after absorbing the acid gas is brought into contact with the hydrophobic membrane. The hydrophobic membrane can selectively allow the nonionic organic compound contained in the absorption liquid to permeate, and separate the nonionic organic compound out of the system. Such separation is performed using a pervaporation method in the present embodiment. The acid gas absorption liquid after the nonionic organic compound is separated by the separator can be supplied to the regenerator.

Such an acid gas removal apparatus will be described below with reference to the drawings.

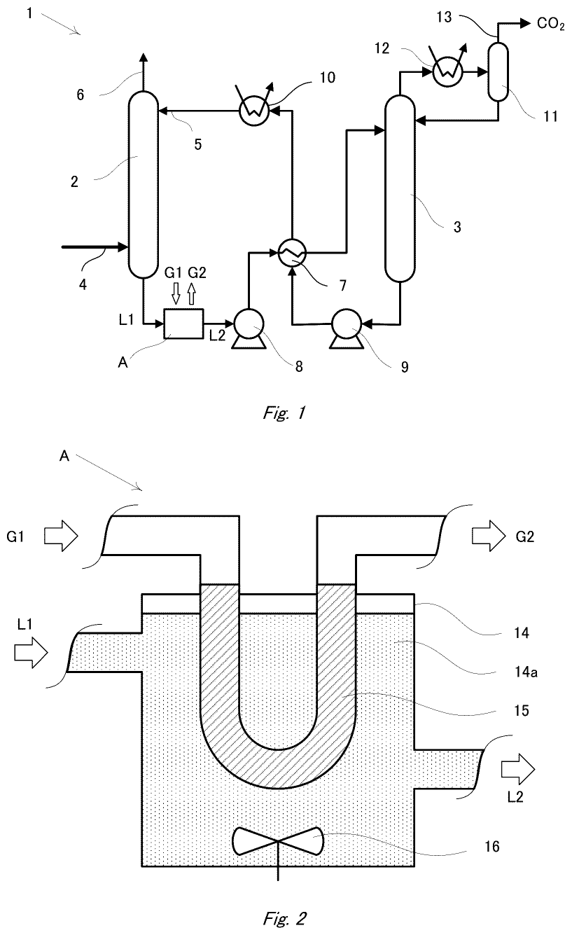

FIG. 1 is a schematic view of an acid gas removal apparatus according to an embodiment.

An acid gas removal apparatus 1 includes an absorber 2 that brings a gas containing an acid gas (for example, exhaust gas) into contact with an acid gas absorption liquid and absorbs and removes the acid gas from the gas containing the acid gas, and a regenerator 3 that separates the acid gas from the acid gas absorption liquid that has absorbed the acid gas and regenerates the acid gas absorption liquid. Hereinafter, a case where the acid gas is carbon dioxide will be described as an example.

As shown in FIG. 1, exhaust gas containing carbon dioxide such as combustion exhaust gas discharged from a thermal power plant or the like is guided to the lower portion of the absorber 2 through a gas supply port 4. The exhaust gas is pushed into the absorber 2 and comes into contact with the acid gas absorption liquid supplied from an acid gas absorption liquid supply port 5 in the upper portion of the absorber 2.

As described above, when the exhaust gas comes into contact with the acid gas absorption liquid, carbon dioxide in the exhaust gas is absorbed and removed by the acid gas absorption liquid. The exhaust gas from which the carbon dioxide has been removed is discharged from a gas discharge port 6 to the outside of the absorber 2.

The acid gas absorption liquid having absorbed carbon dioxide is fed to a separator A, fed from the separator A to a heat exchanger 7, and further fed to the regenerator 3. Here, the driving force of liquid feeding can be performed by a rich liquid pump 8.

In the separator A, the nonionic organic compound contained in the acid gas absorption liquid is separated from the acid gas absorption liquid in the separator A, and is discharged out of the system by the inert gas which is introduced, for example, into the separator A from a line G1, and released from a line G2. The separator A separates at least a part of the nonionic organic compound contained in the acid gas absorption liquid.

The acid gas absorption liquid fed into the regenerator 3 moves from the upper portion to the lower portion of the regenerator 3, and during this time, the acid gas in the acid gas absorption liquid is desorbed, and the acid gas absorption liquid is regenerated.

The acid gas absorption liquid regenerated by the regenerator 3 is fed to the heat exchanger 7 and an absorption liquid cooler 10 by a lean liquid pump 9, and returned from the acid gas absorption liquid supply port 5 to the absorber 2.

On the other hand, the acid gas separated from the acid gas absorption liquid comes into contact with the reflux water supplied from a reflux drum 11 in the upper portion of the regenerator 3, and is discharged to the outside of the regenerator 3.

The reflux water in which the carbon dioxide is dissolved is cooled by a reflux cooler 12, and then separated from the liquid component in which the water vapor accompanied with the carbon dioxide is condensed in the reflux drum 11. This liquid component is guided to the acid gas recovery step by a recovery acid gas line 13. On the other hand, the reflux water from which the acid gas has been separated is fed to the regenerator 3.

One of the features of the acid gas removal apparatus 1 according to the embodiment is that the acid gas removal apparatus 1 includes the separator A.

In FIG. 1, the separator A is provided between the absorber 2 and the heat exchanger 7. In the present embodiment, since the pervaporation method is used for the separation of the nonionic organic compound in the separator A, it is advantageous to perform the separation at a relatively high temperature. Therefore, it is preferable to have a configuration as shown in FIG. 1. However, the separator A is not necessarily disposed between the absorber 2 and the heat exchanger 7, and can be disposed between the heat exchanger 7 and the regenerator 3. A separate bypass may also be provided between the absorber 2 and the regenerator 3, and the separate A may be disposed there.

In the acid gas removal apparatus shown in FIG. 1, the acid gas absorption liquid is fed to the heat exchanger 7 through the separator A once. However, a part of the acid gas absorption liquid that has passed through the separator A can be circulated and supplied to the separator A again. With such a configuration, the nonionic organic compound can be efficiently separated from the acid gas.

Also by arranging a plurality of separators A in series, it is possible to efficiently separate the nonionic organic compound from the acid gas.

Next, a function and a structure of the separator A will be described.

In the acid gas removal method using an acid gas absorption liquid containing an amine compound, a reaction formula when the regenerated gas absorption liquid absorbs CO₂ is as follows.

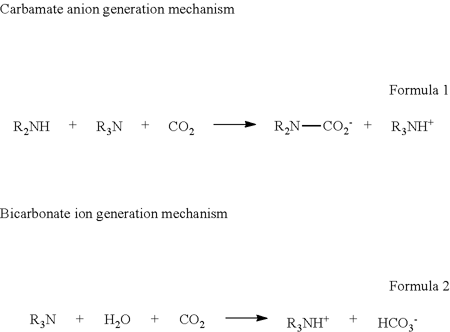

All the salts (ions) generated by the reaction mechanisms represented by Formula 1 and Formula 2 are hydrophilic. The amine compound that is contained in the acid gas absorption liquid and absorbs the acid gas becomes a salt with the acid gas and the amine compound by, for example, a reaction mechanism represented by Formula 1 or Formula 2.

On the other hand, the acid gas absorption liquid includes, for example, a degradation product generated by an oxidation reaction. The degradation product includes a nonionic (hydrophobic) compound. The degradation product is formed by oxidizing the amine compound contained in the acid gas absorption liquid, and thus is generally a nitrogen-containing compound. The nonionic degradation products are usually non-charged molecules. When the acid gas absorption liquid absorbs CO₂, the nonionic degradation product is less likely to be charged than an amine compound that forms a salt by the reaction mechanism. The term “non-charged molecule” includes both a case where the molecule is not charged and a case where, as described above, it is difficult to be charged. The separator A in the embodiment has a function of removing such a nonionic organic compound. As a method for removing the nonionic organic compound, in the present embodiment, pervaporation (pervaporation: PV) separation by a pervaporation membrane is used. Pervaporation (PV) separation by a pervaporation membrane is effective for continuously performing treatment. In the present embodiment, being nonionic means that, for example, the acid dissociation constant (pKa) is 8 or less. In the present embodiment, the acid dissociation constant (pKa) is a value in water at 25° C. In the present embodiment, the acid dissociation constant (pKa) is a value indicating ease of formation of a base. Here, the pKa of the compound can be known from pKa (predicted, most basic temperature: 25° C.) registered in SciFinder (registered trademark).

Incidentally, the nonionic organic compound which is a degradation product is a nitrogen-containing compound generated from an amine, and is generally a nitro-based, aldehyde-based, amide-based, ketone-based, or ester-based nitrogen-containing compound. Specific examples include N-[2-(methyleneamino)ethyl]formamide (6.04), N-2-(hydroxyethyl)formamide (−0.68), 1-nitrosopiperidine (−3.17), 1,4-dimethylpiperazine (7.99), 1,4-diformylpiperazine (1.26), 2,5-pyrrolidinedione (−4.44), piperazin-2-one (7.74), 4-(2-hydroxyethyl)piperazin-2-one (7.38), 3-ethyl-2-oxazolidone (−1.34), and 2-imidazolidinone (−0.059). The value shown in the parentheses is the acid dissociation constant (pKa) of each compound.

Pervaporation (PV) is a method for selectively separating hydrophobic organic molecules from a liquid by utilizing the property that a hydrophobic membrane selectively dissolves hydrophobic organic molecules several tens of thousands times more than water and allows permeation through the membrane. The driving force of the separation is a pressure difference or a concentration difference between the inside and the outside of the separation membrane, and for example, an aqueous solution is caused to flow to the outside of the separation membrane, the inside of the membrane is depressurized, or an inert gas is caused to flow to cause a pressure difference between the inside and the outside of the hydrophobic membrane, and hydrophobic organic molecules present in the aqueous solution in the membrane are released to the outside of the membrane. It is known that the separation factor at this time is proportional to the octanol-water partition factor and the vapor pressure, and the separation performance is improved as the vapor pressure increases regardless of the molecular weight.

A hydrophobic membrane used when a nonionic organic compound is to be separated from an aqueous solution containing the nonionic organic compound by a pervaporation method is a separation membrane capable of separating substances by the pervaporation method. The separation membrane in the present embodiment is a membrane capable of allowing permeation of a nonionic organic compound through an organic substance by using a pressure difference or a concentration difference as a driving force in separation of water-organic substance. For example, in the hydrophobic membrane in the present embodiment, when membrane separation using a pervaporation (PV) method is performed under the same conditions, a nonionic organic compound having a pKa of 8 or less is more likely to permeate than a salt of an amine compound and an acid gas when membrane separation using a pervaporation (PV) method is performed. In the hydrophobic membrane in the present embodiment, the nonionic organic compound having a pKa of 8 or less contained in the acid gas absorption liquid that has absorbed the acid gas is more likely to permeate than the salt of the amine compound and the acid gas.

The separation membrane may be made of an organic material or an inorganic material, but a hydrophobic organic polymer membrane made of an organic material is preferable. Various materials for such hydrophobic organic polymer membranes are known, and suitable examples thereof include fluorine-containing polymers such as polytetrafluoroethylene, silicone polymers such as polydimethylsiloxane and polytrimethylsilylpropyne, vinyl polymers such as polyvinyl ether and crosslinked polyvinyl ester, and polyether-polyamide copolymers. Preferable examples thereof include polytetrafluoroethylene, polydimethylsiloxane, polytrimethylsilylpropyne, polyvinyl ether, crosslinked polyvinyl ester, and polyether-polyamide copolymer. For example, since polytetrafluoroethylene has high chemical resistance, membrane degradation is less likely to occur, long-term use becomes possible, and thus CO₂ recovery costs can be reduced. As the inorganic material, a hydrophobic zeolite membrane having a high Si/Al ratio (molar ratio of silicon to aluminum) can also be used. For example, the Si/Al ratio is preferably 4.5 or more and 10,000 or less. For example, the Si/Al ratio is more preferably 5.0 or more and 10,000 or less.

The degree of hydrophobicity of the separation membrane can be evaluated, for example, by water contact angle measurement. When the water contact angle at 25° C. is less than 30°, it is said that hydrophilicity is high, and as the water contact angle becomes higher, hydrophobicity and water repellency become higher. The water contact angle of the hydrophobic membrane in the present embodiment is preferably 70 to 150° and more preferably 80 to 130° at 25° C.

The shape of the separation membrane used in the separator in the embodiment is not particularly limited, and there is a tube type (hollow fiber type) in addition to the simplest flat membrane type. The tube type is preferably used in the present embodiment because it is easy to bundle a plurality of tubes with a manifold to form a module.

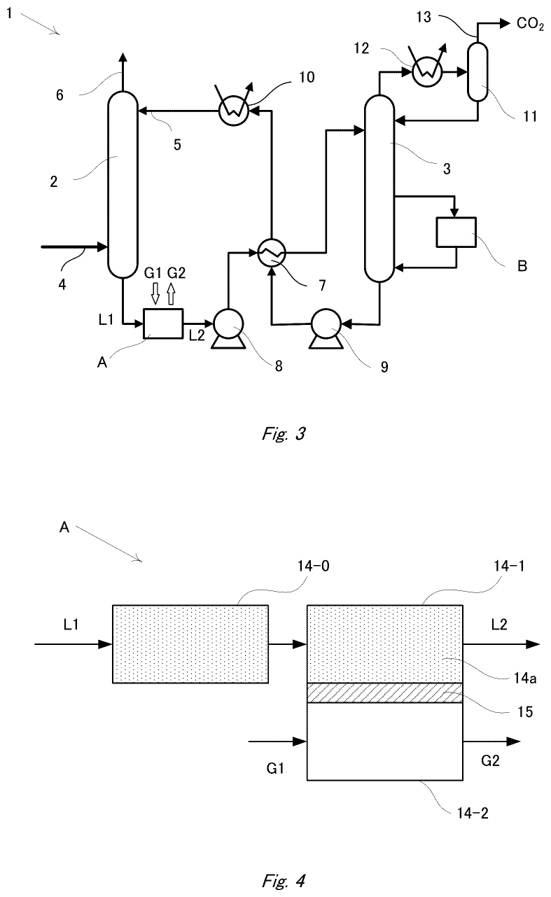

FIG. 2 is a schematic view of the separator A that can be used in the present embodiment. The separator A includes a storage tank 14 capable of temporarily retaining an acid gas absorption liquid 14a introduced from a pipe L1 connecting the absorber 2 and the separator A, and the storage tank 14 and the heat exchanger 7 (or a liquid feeding pump 8) are connected by a pipe L2. It is also possible to provide a stirring apparatus 16, for example, a rotary blade, for stirring the acid gas absorption liquid in the storage tank. In FIG. 2, the inside of the pipe is hollow, and the outside of the pipe is liquid.

In FIG. 2, a separation membrane 15 in the form of a tube (hollow fiber membrane) made of a hydrophobic material is connected to the introduction pipe G1 and the discharge pipe G2, and is immersed in the acid gas absorption liquid 14a retained in the storage tank 14.

The acid gas absorption liquid released from the absorber contains a hydrophilic amine carbonate formed from an amine compound and carbon dioxide, but this salt is hydrophilic, does not infiltrate the separation membrane, and hardly permeates the separation membrane. Meanwhile, the nonionic organic compound, which is a nonionic compound contained in the acid gas absorption liquid, does not react with carbon dioxide and is hydrophobic, and thus the nonionic organic compound permeates the separation membrane made of a hydrophobic material while infiltrating the separation membrane. As a result, the hydrophobic nonionic organic compound can be selectively and easily removed.

In order to increase the separation efficiency, for example, the inside of the pipe connected to the tube can be depressurized. For example, the pressure is reduced to 10 kPa or less. The pressure is more preferably reduced to 1 kPa or less. The pressure is more preferably reduced to 50 Pa or less. The pressure is more preferably reduced to 10 Pa or less. Specifically, the introduction pipe G1 is closed, and the gas inside the pipe is discharged from the discharge pipe G2 by a pressure reducing apparatus such as a vacuum pump to achieve pressure reduction, and the separated gaseous nonionic organic compound that has passed through the separation membrane 15 from the acid gas absorption liquid can be discharged from the discharge pipe G2 to the outside of the system. In addition, an inert gas such as nitrogen or argon or dry air as a sweep gas can be introduced from the introduction pipe G1 by an inert gas introduction apparatus such as a compressor or a cylinder, passed through the tubular separation membrane 15, and released from the discharge pipe G2. When the inert gas or the like passes through the inside of the separation membrane, the nonionic organic compound is released in a gaseous form from the inner surface of the separation membrane into the separation membrane.

In order to evaluate the separation performance by the separator, the amount of the amine compound (GC purity) may be compared by GC/MS by sampling the acid gas absorption liquid before introducing the acid gas absorption liquid having absorbed the acid gas into the separator and after performing the separation by the separator.

For the GC/MS, for example, a gas chromatography mass spectrometer 5975 manufactured by Agilent Technologies Inc. is used. As the measurement conditions, the column can be Rtx-35Amine, the oven temperature can be 40° C., the split ratio can be 20, and the measurement range can be m/z 40 to 550.

The sampled acid gas absorption liquid is diluted 100 times with methanol, and a GC/MS spectrum thereof is measured. From this result, the separation performance can be evaluated by the ratio between the amine compound and the degradation product in the acid gas absorption liquid before passing through the separator and the ratio between the amine compound and the degradation product in the acid gas absorption liquid after passing through the separator.

The inert gas having passed through the separator and the separated nonionic organic compound are discharged as they are to the outside of the system. For example, in FIG. 2, a nonionic organic compound recovery unit may be provided at the subsequent stage of the discharge pipe G2 to recover the nonionic organic compound. Usually, the inert gas and the nonionic organic compound are not returned to the regenerator, and the acid gas is removed by the acid gas absorption liquid in a state where the amount of degradation products is small. Since the separated nonionic organic compound or the inert gas containing the nonionic organic compound is in a gaseous state, the nonionic organic compound or the inert gas or the nonionic organic compound can be condensed by a cooler, adsorbed to an adsorbent such as a hydrophobic zeolite, or, when the amount is small, absorbed in water and recovered. Meanwhile, the acid gas absorption liquid from which the nonionic organic compounds have been separated and which has been purified may contain water-soluble degradation products such as hydrophilic amine carbonates, but the acid gas absorption liquid can be introduced into the regenerator as is and reused.

In the present embodiment, the separator A separates a degradation product of the nonionic organic compound. In the present embodiment, as shown in FIG. 3, a thermal reclaimer B can be provided, for example, additionally to the regenerator 3. The thermal reclaimer B heats and evaporates the acid gas absorption liquid from which the acid gas has been desorbed by the regenerator, and recovers the acid gas absorption liquid, and can separate degradation products such as a thermally stable salt that does not volatilize as a residue. By using the separator A in combination, degradation products can be more effectively separated. In the present embodiment, the nonionic organic compound can also be supplementarily separated by passing the acid gas absorption liquid through a membrane of hydrophobic zeolite or the like.

In the present embodiment, an apparatus using an electrodialysis method may be used in combination as an apparatus for separating degradation products. In the apparatus using the electrodialysis method, hydrophilic degradation products such as thermally stable salts, and water-soluble degradation products can be separated. As an example of the thermally stable salt, there is a thermally stable amine salt generated by an acid gas absorption liquid (containing an amine compound) absorbing an inorganic acid (for example, SOx, NOx, carbonyl sulfide, hydrogen cyanide, thiocyanate, thiosulfate) contained in carbon dioxide exhaust gas. The apparatus using the electrodialysis method can be arranged, for example, between the regenerator 3 and the heat exchanger 7.

The configuration of the separator is not limited to that shown in FIG. 2. For example, the separator A may have a configuration as shown in FIG. 4. The separator A includes a first chamber 14-1 and a second chamber 14-2, and the two chambers are joined via the separation membrane 15. The acid gas absorption liquid that has absorbed the acid gas and is introduced from L1 is introduced into the first chamber 14-1 via a preliminary storage tank 14-0 that is disposed as necessary and can temporarily store the acid gas absorption liquid. An inert gas is introduced from an inert gas introduction apparatus (not shown) into the second chamber 14-2 through the introduction pipe G1, and the inside of the second chamber 14-2 is filled with the inert gas. The inert gas is discharged from the discharge pipe G2 by a pressure reducing apparatus (not shown), and the inside of the second chamber 14-2 is depressurized. The nonionic organic compound contained in the acid gas absorption liquid 14a passes through the separation membrane 15, and the gaseous nonionic organic compound is discharged from the discharge pipe G2 to the outside of the system. The acid gas absorption liquid from which the nonionic organic compound has been separated is discharged from the first chamber 14-1 and supplied to a regeneration tower 3 via the heat exchanger 8.

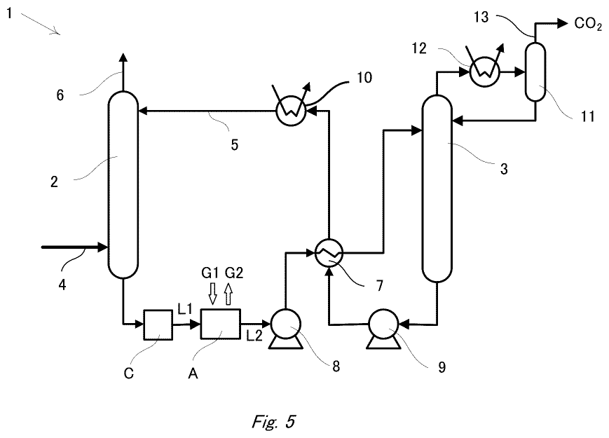

FIG. 5 shows a schematic view of the acid gas removal apparatus 1 according to another embodiment. The acid gas removal apparatus 101 is provided with a carbon dioxide introduction apparatus C between the absorber 2 and the separator A. The carbon dioxide introduction apparatus C introduces carbon dioxide into the acid gas absorption liquid derived from the absorber 2. When the carbon dioxide introduction apparatus C adds carbon dioxide to the acid gas absorption liquid, an unreacted amine compound can be reacted to generate a salt of the amine compound and the acid gas. Such additional introduction of carbon dioxide is effective when the carbon dioxide content in the acid gas absorption liquid is low, for example, immediately after the start of operation of the carbon dioxide removal apparatus. While the unreacted amine compound is easily removed by the separator, the salt is hardly separated, and thus the nonionic organic compound, which is a degradation product, can be more effectively separated by the separator A, and the loss of the unreacted amine compound can be suppressed.

Here, the carbon dioxide introduction apparatus C has a function of dissolving carbon dioxide in the acid gas absorption liquid. For example, it is possible to introduce the acid gas absorption liquid into a tank filled with a gas containing carbon dioxide, to bring the carbon dioxide and the acid gas absorption liquid into contact with each other, or dissolve carbon dioxide by bubbling carbon dioxide or pressurizing carbon dioxide into the acid gas absorption liquid. Therefore, examples of the carbon dioxide introduction apparatus C include a tank filled with a gas containing carbon dioxide, an apparatus for bubbling a gas containing carbon dioxide, and an apparatus for dissolving carbon dioxide by pressurizing carbon dioxide into the acid gas absorption liquid. In addition, the volume concentration of carbon dioxide in the gas introduced from the carbon dioxide introduction apparatus C is preferably high, preferably 5 to 100 vol %, and more preferably 10 to 100 vol % from the viewpoint of the treatment speed.

### <Method for Removing Acid Gas>

The acid gas removal method according to the present embodiment includes:
an absorption step of bringing a gas to be treated containing an acid gas into contact with an acid gas absorption liquid containing an amine compound to absorb the acid gas in the gas to be treated into the acid gas absorption liquid; and
a regeneration step of desorbing an acid gas from an acid gas absorption liquid after absorption of the acid gas to regenerate the acid gas absorption liquid, and
the acid gas absorption liquid regenerated in the regeneration step is reused in the absorption step.

The acid gas removal method in the present embodiment further includes a separation step of separating the nonionic organic compound contained in the acid gas absorption liquid treated in the acid gas absorption step from the acid gas absorption liquid. In this separation step, the acid gas absorption liquid treated in the absorption step is brought into contact with the hydrophobic membrane, and the nonionic organic compound is separated by allowing the nonionic organic compound to permeate through the hydrophobic membrane. The acid gas absorption liquid after separation of the nonionic organic compound is subjected to a regeneration step.

Such an acid gas removal method can be typically performed by the above-described acid gas removal apparatus.

The amine compound used in the acid gas removal method in the embodiment is not particularly limited and may be generally one used for removing an acid gas. In general, alkanolamines represented by monoethanolamine (MEA) and cyclic diamines are known. Such alkanolamines have been developed since the 1930s and are still used today.

Examples of typical alkanolamines used in the absorption method include 2-amino-2-methylpropanolamine, methylaminoethanol, ethylaminoethanol, propylaminoethanol, monoethanolamine, diethanolamine, methyldiethanolamine, dimethylethanolamine, diethylethanolamine, triethanolamine, or dimethylamino-1-methylethanol.

Examples of cyclic diamines include:
piperazine,
1-(2-hydroxyethyl)piperazine,
1-(2-aminoethyl)piperazine,
1,4-bis [3-aminopropyl]piperazine,
N-isopropyldiethanolamine,
N-isopropyldipropanolamine,
N-isopropyldibutanolamine,
N-isopropyldipentanolamine,
N-isopropyldihexanolamine,
3-[(2-hydroxyethyl)(propan-2-yl)amino]propan-1-ol,
4-[(2-hydroxyethyl)(propan-2-yl)amino]butan-1-ol,
5-[(2-hydroxyethyl)(propan-2-yl)amino]pentan-1-ol,
6-[(2-hydroxyethyl)(propan-2-yl)amino]hexan-1-ol,
N-sec-butyldiethanolamine,
N-sec-butyldipropanolamine,
N-sec-butyldibutanolamine,
N-sec-butyldipentanolamine,
N-sec-butyldihexanolamine,
3-[(2-hydroxyethyl)(butan-2-yl)amino]propan-1-ol,
4-[(2-hydroxyethyl)(butan-2-yl)amino]butan-1-ol,
5-[(2-hydroxyethyl)(butan-2-yl)amino]pentan-1-ol,
6-[(2-hydroxyethyl)(butan-2-yl)amino]hexan-1-ol,
N-cyclopentyldiethanolamine,
N-cyclopentyldipropanolamine,
N-cyclopentyldibutanolamine,
N-cyclopentyldipentanolamine,
N-cyclopentyldihexanolamine,
3-[(2-hydroxyethyl)(cyclopentyl)amino]propan-1-ol,
4-[(2-hydroxyethyl)(cyclopentyl)amino]butan-1-ol,
5-[(2-hydroxyethyl)(cyclopentyl)amino]pentan-1-ol,
6-[(2-hydroxyethyl)(cyclopentyl)amino]hexan-1-ol,
2-azetidinemethanol,
2-(2-aminoethyl)azetidine,
2-pyrrolidinemethanol,
2-(2-aminoethyl)pyrrolidine,
2-piperidinemethanol,
3-piperidineethanol,
2-(2-aminoethyl)pyrrolidine,
1-(2-hydroxyethyl)piperazine,
2-(hydroxymethyl)piperazine,
3-hydroxypyrrolidine,
3-pyrrolidinemethanol,
2-(2-hydroxyethyl)pyrrolidine,
4-piperidineethanol,
3-hydroxypiperidine,
4-hydroxypiperidine,
4-(hydroxymethyl)piperidine, and
3-aminopiperidine.

Among these,
piperazine,
1-(2-hydroxyethyl)piperazine,
1-(2-aminoethyl)piperazine,
1,4-bis [3-aminopropyl]piperazine,
N-isopropyldiethanolamine,
N-isopropyldipropanolamine,
3-[(2-hydroxyethyl)(propan-2-yl)amino]propan-1-ol,
N-sec-butyldiethanolamine,
N-sec-butyldipropanolamine,
N-sec-butyldibutanolamine,
3-[(2-hydroxyethyl)(butan-2-yl)amino]propan-1-ol,
N-cyclopentyldiethanolamine,
N-cyclopentyldipropanolamine, and
3-[(2-hydroxyethyl)(cyclopentyl)amino]propan-1-ol
   are preferred.

Furthermore, a cyclic diamine represented by Formula (1a) or (1b) can also be used. These cyclic amines are also preferable.

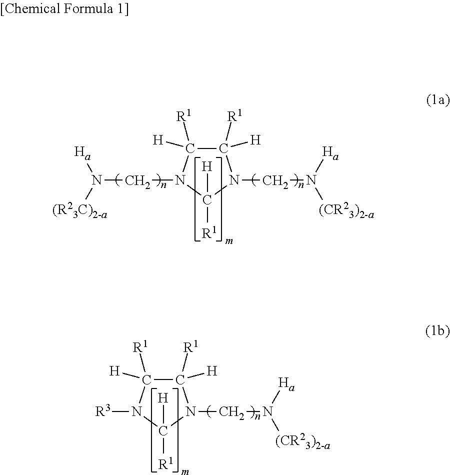

In the formula,
R¹'s are each independently a hydrogen or an unsubstituted or substituted alkyl group having 3 or fewer carbon atoms,
R²'s are each independently a hydrogen or an unsubstituted or substituted alkyl group having 3 or fewer carbon atoms,
among the R²'s included in one —CR²₃, at least two are not hydrogen,
R³'s are a hydrogen or an unsubstituted or substituted alkyl group having 4 or fewer carbon atoms,
a's are each independently 0 or 1,
m is a number from 1 to 3, and
n's are each independently a number from 1 to 4.

More specifically, R¹ and R³ are each independently hydrogen, a methyl group, an ethyl group, a propyl group, or an isopropyl group, and R² is hydrogen, a methyl group, or an ethyl group. m is preferably 2, and n is preferably 2 to 3.

The acid gas absorption liquid in the embodiment may contain an alkanolamine or a cyclic diamine alone, or may contain a combination of two or more thereof, or may contain a combination of two or more cyclic diamines.

The higher the content of the amine compound contained in the acid gas absorption liquid, the larger the amount of carbon dioxide absorbed and desorbed per unit volume, and the higher the rate of carbon dioxide absorbed and desorbed, which is preferable in terms of energy consumption and treatment efficiency. In general, when the content of the amine compound in the acid gas absorption liquid is too high, the viscosity of the absorption liquid tends to increase. From these, the total content of the amine compound is preferably 5 to 60 mass %, and more preferably 10 to 50 mass %, based on the total mass of the acid gas absorption liquid.

In the present embodiment, the acid gas absorbent may further contain an optional component as necessary. Examples of the optional component include an antioxidant, a pH adjusting agent, an antifoaming agent, and an anticorrosive agent.

The antioxidant can prevent degradation of the acid gas absorption liquid and improve the life thereof. Preferable specific examples of the antifoaming agent include a silicone-based antifoaming agent and an organic antifoaming agent. When the antifoaming agent is used, the content based on the total mass of the acid gas absorption liquid is preferably 0.00001 to 0.001 mass %, and particularly preferably 0.0005 to 0.001 mass %.

The antifoaming agent can prevent foaming of the acid gas absorption liquid, suppress a decrease in absorption efficiency and separation efficiency of the acid gas, and prevent a decrease in fluidity or circulation efficiency of the acid gas absorption liquid.

Preferable specific examples of the anticorrosive agent include phosphoric acid esters, tolyltriazoles, and benzotriazoles. When an anticorrosive agent is used, the content based on the total mass of the acid gas absorption liquid is preferably 0.00003 to 0.0008 mass %, and particularly preferably 0.00005 to 0.005 mass %. Such an anticorrosive agent can prevent corrosion of plant equipment and improve the life thereof.

Hereinafter, the present embodiment will be described more specifically with reference to examples, but the conditions in the examples are merely examples adopted to confirm the feasibility and effects of the present embodiment, and the present embodiment is not limited to these condition examples. The present embodiment can adopt various conditions as long as the object of the present embodiment is achieved without departing from the gist of the present embodiment.

### Example 1

As an acid gas absorption liquid, an aqueous solution containing piperazine (PZ) at a concentration of 50 mass % was prepared. A sample was prepared by absorbing a certain amount of carbon dioxide in the acid gas absorption liquid.

A gas pipe was connected to both ends of a silicon tube (inner diameter 4 mm, outer diameter 5 mm) 200 mm made of polydimethylsiloxane (PDMS), 150 ml of a sample was placed in a 300 ml container having a lid, and then the silicon tube was disposed to be immersed in water. The acid gas absorption liquid was stirred at a speed of about 100 rpm by a rotor. Argon gas was vented at 100 ccm from one side of the gas pipe, and the other side was inserted into water in a separately prepared beaker to perform bubbling. The acid gas absorption liquid before introduction of argon gas was measured by GC/MS. After 2 hours from the start of the introduction of the argon gas, the acid gas absorption liquid was sampled again and measured by GC/MS. Treatment and measurements were performed at 25° C.

### Example 2

Evaluation was performed under the same conditions as in Example 1, except that the piperazine in Example 1 was replaced with 1-(2-aminoethyl)piperazine (AEPZ).

### Example 3

Evaluation was performed under the same conditions as in Example 1, except that the piperazine in Example 1 was replaced with 1-(2-hydroxyethyl)piperazine (HEPZ).

### Example 4

Evaluation was performed under the same conditions as in Example 3, except that the experimental duration in Example 3 was changed to 8 hours.

### Example 5

Evaluation was performed under the same conditions as in Example 1, except that the piperazine in Example 1 was replaced with ethylaminoethanol (EAE).

### Example 6

Evaluation was performed under the same conditions as in Example 5, except that the experimental duration in Example 5 was changed to 8 hours.

### Comparative Example 1

Evaluation was performed under the same conditions as in Example 1, except that the silicone tube of Example 1 was replaced with a nylon tube. Nylon tubes are more hydrophilic than PDMS.

When the amine compound in the acid gas absorption liquid is piperazine, the nonionic (hydrophobic) degradation product contains, for example, 2-piperazinone. When the amine compound in the acid gas absorption liquid is HEPZ, AEPZ, or EAE, the degradation product contains, for example, 2-oxazolidone. The degradation product may have various structures, and is not limited to the above.

The data obtained in each example is summarized as shown in Table 1.

TABLE 1

| | | | GC concentration before | | | GC concentration after | |
|---|---|---|---|---|---|---|---|
| | Separation | | separation treatment (%) | | | separation treatment (%) | |
| | membrane | Amine | Amine | Degradation | Processing | Amine | Degradation |
| | material | compound | compound | product | time (hours) | compound | product |
| Example 1 | PDMS | PZ | 60 | 40 | 2 | 66 | 34 |
| Example 2 | PDMS | AEPZ | 65 | 35 | 2 | 70 | 30 |
| Example 3 | PDMS | HEPZ | 71 | 29 | 2 | 75 | 25 |
| Example 4 | PDMS | HEPZ | 71 | 29 | 8 | 86 | 14 |
| Example 5 | PDMS | EAE | 55 | 45 | 2 | 59 | 41 |
| Example 6 | PDMS | EAE | 55 | 45 | 8 | 67 | 33 |
| Reference | Nylon | PZ | 60 | 40 | 2 | 58 | 42 |
| Example 1 | | | | | | | |

From Examples 3 and 4, it can be seen that as the separation time is longer, the degradation products decrease, and the concentration of the degradation products is decreased by the separation treatment, and the acid gas absorption liquid is purified. In Comparative Example 1, since the tube was not hydrophobic, the amine compound that was hydrophilic was separated out of the system together with the nonionic organic compound that was a degradation product, the concentration of the degradation product in the acid gas absorption liquid relatively increased, and the purification effect of the acid gas absorption liquid was not obtained.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and sprit of the invention.

### REFERENCE SIGNS LIST

1 Acid gas removal apparatus
2 Absorber
3 Regenerator
4 Gas supply port
5 Acid gas absorption liquid supply port
6 Gas discharge port
7 Heat exchanger
8 Rich liquid pump
9 Lean liquid pump
10 Absorption liquid cooler
11 Reflux drum
12 Reflux cooler
13 Recovery acid gas line
14 Storage tank
14a Acid gas absorption liquid
14-0 Preliminary storage tank
14-1 First chamber
14-2 Second chamber
15 Separation membrane
16 Stirring apparatus
A Separator
B Thermal reclaimer
C Carbon dioxide introduction apparatus

1. An acid gas removal apparatus comprising:
an absorber that brings a gas to be treated containing acid gas into contact with an acid gas absorption liquid containing an amine compound to absorb the acid gas in the gas to be treated into the acid gas absorption liquid; and
a regenerator that desorbs the acid gas from the acid gas absorption liquid after acid gas absorption to regenerate the acid gas absorption liquid, wherein
the acid gas absorption liquid regenerated by the regenerator is reused in the absorber,
the acid gas removal apparatus further comprises a separator that separates a nonionic organic compound contained in the acid gas absorption liquid after the acid gas absorption from the acid gas absorption liquid,
the separator is provided with a hydrophobic membrane, brings the acid gas absorption liquid derived from the absorber into contact with the hydrophobic membrane, and separates the nonionic organic compound by allowing the nonionic organic compound to permeate the hydrophobic membrane, and
the acid gas absorption liquid after the nonionic organic compound is separated by the separator is capable of being supplied to the regenerator.

2. The acid gas removal apparatus according to claim 1, wherein the nonionic organic compound separated by the separator is not supplied to the regenerator.

3. The acid gas removal apparatus according to claim 1, wherein the nonionic organic compound separated by the separator is a gas.

4. The acid gas removal apparatus according to claim 1, wherein the acid gas absorption liquid after the nonionic organic compound is separated by the separator contains a salt of an amine compound and an acid gas.

5. The acid gas removal apparatus according to claim 1, wherein the nonionic organic compound contains a nitrogen-containing compound.

6. The acid gas removal apparatus according to claim 1, wherein the nonionic organic compound is a non-charged molecule.

7. The acid gas removal apparatus according to claim 1, wherein the hydrophobic membrane is a separation membrane capable of separating substances by a pervaporation method.

8. The acid gas removal apparatus according to claim 1, wherein the hydrophobic membrane is a hydrophobic organic polymer membrane.

9. The acid gas removal apparatus according to claim 1, further comprising:
a heat exchanger that transmits heat of the acid gas absorption liquid regenerated by the regenerator to the acid gas absorption liquid after acid gas absorption, wherein
the separator is disposed between the absorber and the heat exchanger.

10. The acid gas removal apparatus according to claim 1, further comprising a thermal reclaimer.

11. The acid gas removal apparatus according to claim 1, wherein a part of the acid gas absorption liquid after the nonionic organic compound is separated by the separator is circularly supplied to the separator before being introduced into the regenerator.

12. The acid gas removal apparatus according to claim 1, wherein a plurality of the separators are disposed in series.

13. The acid gas removal apparatus according to claim 1, wherein the nonionic organic compound which has permeated through said hydrophobic membrane is a gas.

14. An acid gas removal method comprising:
an absorption step of bringing a gas to be treated containing acid gas into contact with an acid gas absorption liquid containing an amine compound to absorb the acid gas in the gas to be treated into the acid gas absorption liquid; and
a regeneration step of desorbing the acid gas from the acid gas absorption liquid after acid gas absorption to regenerate the acid gas absorption liquid, wherein
the acid gas absorption liquid regenerated in the regeneration step is reused in the absorption step,
the acid gas removal method further comprises a separation step of separating a nonionic organic compound contained in the acid gas absorption liquid treated in the acid gas absorption step from the acid gas absorption liquid, and
the separation step brings the acid gas absorption liquid treated in the absorption step into contact with a hydrophobic membrane, and separates the nonionic organic compound by allowing the nonionic organic compound to permeate the hydrophobic membrane, and
the acid gas absorption liquid after the nonionic organic compound is separated by the separation step is subjected to the liquid regeneration step.

15. (a) The acid gas removal method according to claim 14, wherein the absorption step is performed at 60° C. or lower.

16. (b) The acid gas removal method according to claim 14, wherein the regeneration step is performed at 70° C. or higher.

17. A separator that separates a nonionic organic compound contained in an acid gas absorption liquid after acid gas absorption from the acid gas absorption liquid, wherein
the separator is provided with a hydrophobic membrane, brings the acid gas absorption liquid into contact with the hydrophobic membrane, and separates the nonionic organic compound by allowing the nonionic organic compound to permeate the hydrophobic membrane, and
the permeated nonionic organic compound is a gas.

18. The separator according to claim 17, wherein the hydrophobic membrane is a separation membrane capable of separating substances by a pervaporation method.
